(19) United States
(12) Patent Application Publication
(10) Pub. No.: US 2004/0033180 A1
(43) Pub. Date: Feb. 19, 2004

(54) Method and apparatus for producing silicon oxide-based ceramic membrane by gas phase synthesis

(75) Inventors: Masahiko Matsukata, Tokyo (JP); Shuji Tsuruoka, Tokyo (JP); Shiro Ikeda, Tokyo (JP)

Correspondence Address: SUGHRUE MION, PLLC, 2100 PENNSYLVANIA AVENUE, N.W., WASHINGTON, DC, 20037, US

(73) Assignee: WASEDA UNIVERSITY, BIO NANOTEC RESEARCH INSTITUTE INC.

(21) Appl. No.: 10/641,086

(22) Filed: Aug. 15, 2003

(30) Foreign Application Priority Data
Aug. 15, 2002 (JP) 2002-237134

(51) Int. Cl. B01J 8/00; B01J 35/00

(52) U.S. Cl. 422/209; 502/4; 422/187; 422/198; 422/219

(57) ABSTRACT

A method for producing a silicon oxide-based ceramic membrane on a surface of a porous substrate from a silica source and an aqueous alkaline solution (or an aqueous alkaline solution of an alumina source) by a gas phase reaction comprises the step of heating the silica source and the aqueous alkaline solution (or the aqueous alkaline solution of an alumina source) in an airtight vessel without mixing them.

### FIELD OF THE INVENTION

The present invention relates to a method and an apparatus for producing a silicon oxide-based ceramic membrane having pores with a uniform size, which are usable as a molecular sieve, a catalyst carrier, etc.

### BACKGROUND OF THE INVENTION

Zeolites are crystalline aluminosilicate having pores with a molecular level size. Allowing molecules to pass through selectively depending on their sizes and shapes, zeolite membranes have been widely used as molecular sieves. The term “membrane” used herein means a thin layer, which is usually coated on a substrate. There have been many reports on such zeolite membranes and their production methods. For example, methods for producing zeolite membranes by hydrothermal reactions in aqueous solutions, gels, or sols have been reported in JP 08-131795 A, JP 08-257301 A, JP 08-257302 A, JP 09-071481 A, JP 10-212117 A, JP 11-209120 A, JP 2000-042387 A, JP 2000-225327 A, JP 2001-240411 A, JP 2002-047213 A, etc.

Disclosed in JP 2002-18247 A is a method for forming a membrane of a ZSM-5 zeolite, where seed crystals of the ZSM-5 zeolite are deposited onto a surface of a porous substrate, and the porous substrate is soaked in a mother liquor of the ZSM-5 zeolite and heated to make crystals of the ZSM-5 zeolite grow on the porous substrate. Thus-obtained ZSM-5 zeolite membrane can be used as a separation membrane with excellent separating function.

The hydrothermally synthesized zeolite membranes are dense and have uniform pores, thereby showing excellent separating function as the molecular sieve. However, because the mother liquor of starting materials is heated with the substrate in the hydrothermal synthesis, the mother liquor cannot be used repeatedly, resulting in high material cost.

Further, because an aqueous solution or a gel of a silica source and an alumina source is heated in the hydrothermal syntheses to form the zeolite membrane on the substrate by a liquor phase reaction, the concentration ratio of the silica source to the alumina source is changed as the reaction progresses. Thus, the liquor phase reaction is disadvantageous in that the zeolite crystal system changes as the reaction progresses, so that a zeolite membrane with a uniform crystal structure is hardly formed.

Disclosed in JP 63-17216 A is a method where silica is deposited onto a basic zeolite by a chemical vapor deposition method, to control the pore opening size of the zeolite. In this method, a silica layer is formed on a zeolite substrate by a chemical vapor deposition method using a silanizing agent, and hydroxyl groups are formed on the silica layer by a steam treatment. The silica layer can be repeatedly formed on the zeolite, so that the size of pore openings can be controlled. However, this method is complicated because of the repetition of the two steps.

### OBJECT OF THE INVENTION

Accordingly, an object of the present invention is to provide a method and an apparatus for producing a silicon oxide-based ceramic membrane having pores with a uniform size at a low cost.

### SUMMARY OF THE INVENTION

As a result of intense research in view of the above object, the inventors have found that (a) a silicon oxide-based ceramic membrane having pores with a uniform size can be produced by a method where a silica source and an aqueous alkaline solution (or an aqueous alkaline solution of an alumina source) are heated in an airtight vessel without mixing to cause a gas phase reaction of the silica source (or between the silica source and the alumina source) on a porous substrate, that (b) this method can reduce consumption of the starting materials more than conventional hydrothermal synthesis methods, and that (c) this method can successively produce the silicon oxide-based ceramic membrane. The present invention has been completed based on the findings.

Thus, the method of the present invention for producing a silicon oxide-based ceramic membrane on a surface of a porous substrate from a silica source and an aqueous alkaline solution (or an aqueous alkaline solution of an alumina source) by a gas phase reaction comprises the step of heating the silica source and the aqueous alkaline solution (or the aqueous alkaline solution of an alumina source) in an airtight vessel without mixing them.

In the present invention, the aqueous alkaline solution (or the aqueous alkaline solution of an alumina source) is preferably put onto the porous substrate before the gas phase reaction. Further, a seed crystal of a silicon oxide-based ceramic and/or a crystallization-accelerating agent is preferably deposited onto the porous substrate before the gas phase reaction.

The gas phase reaction is carried out preferably at a temperature of 250° C. or lower. The gas phase reaction is preferably carried out under a pressure of 4 MPa or less. The porous substrate is preferably made of ceramics, organic high-molecular compounds or metals.

The silica source is preferably a silicon compound that is vaporized and hydrolyzed at a temperature equal to or lower than the gas phase reaction temperature, or a silicon compound that reacts with an aluminum compound to form an aluminosilicate at a temperature equal to or lower than the gas phase reaction temperature, more preferably a silicon alkoxide. Preferred as the silicon alkoxides are tetraethoxysilane and tetramethoxysilane. The alumina source is preferably selected from the group consisting of sodium aluminate, aluminum hydroxide, aluminum sulfate, metallic aluminum, aluminum isopropoxide and colloidal alumina, more preferably sodium aluminate. Further, the aqueous alkaline solution (or the aqueous alkaline solution of the alumina source) preferably contains a seed crystal of the silicon oxide-based ceramic and/or a crystallization-accelerating agent.

The method for producing a silicon oxide-based ceramic membrane on a surface of a porous substrate according to a preferred embodiment of the present invention comprises placing the porous substrate, a silica source and an aqueous alkaline solution in an airtight vessel, such that the silica source is not mixed with the aqueous alkaline solution; keeping a surface of the porous substrate wet with the aqueous alkaline solution; raising the internal temperature of the airtight vessel to a temperature equal to or higher than the vaporization temperature of the silica source to vaporize the silica source, thereby causing the silica source to react with the aqueous alkaline solution on the porous substrate to form the silicon oxide-based ceramic membrane. The silicon oxide-based ceramic produced by this method is preferably made of silica

The method for producing a silicon oxide-based ceramic membrane on a surface of a porous substrate according to another preferred embodiment of the present invention comprises placing the porous substrate, a silica source and an aqueous alkaline solution of an alumina source in an airtight vessel, such that the silica source is not mixed with the aqueous alkaline solution of an alumina source; keeping a surface of the porous substrate wet with the aqueous alkaline solution of an alumina source; raising the internal temperature of the airtight vessel to a temperature equal to or higher than the vaporization temperature of the silica source to vaporize the silica source, thereby causing the silica source to react with the aqueous alkaline solution of an alumina source on the porous substrate to form the silicon oxide-based ceramic membrane. The silicon oxide-based ceramic membrane produced by this method is preferably made of zeolite.

The first airtight vessel for producing a silicon oxide-based ceramic membrane on a surface of a porous substrate from a silica source and an aqueous alkaline solution (or an aqueous alkaline solution of an alumina source) according to the present invention comprises a pipe having a closed end and an open end; a support fixed to the closed end of the pipe and protruding inward from an inner surface thereof; a cover member airtightly engaging the open end of the pipe; a projection protruding inward from an inner surface of the cover member for fixedly supporting the porous substrate; and a suspension container rotatably attached to the projection such that an open end of the suspension container is always directed substantially above.

The further feature of the first airtight vessel of the present invention is that when the airtight vessel is heated while rotating with the aqueous alkaline solution (or the aqueous alkaline solution of an alumina source) introduced into the pipe, with the cover member airtightly engaging the open end of the pipe such that the porous substrate engaging the support is fixed by the projection, and with the silica source charged into the suspension container, the silica source is vaporized without mixing with the aqueous alkaline solution (or the aqueous alkaline solution of an alumina source), and the aqueous alkaline solution (or the aqueous alkaline solution of an alumina source) is partly dropped onto the porous substrate while wetting the inner wall of the pipe, whereby the vaporized silica source reacts with the aqueous alkaline solution (or the aqueous alkaline solution of an alumina source) on the porous substrate to form the silicon oxide-based ceramic membrane. In the first airtight vessel, it is preferable that a ring-shaped internal flange is disposed inside the pipe between an end surface of the porous substrate and the cover member, and that the aqueous alkaline solution (or the aqueous alkaline solution of an alumina source) is placed between the closed end of the pipe and the ring-shaped internal flange.

The second airtight vessel of the present invention for producing a silicon oxide-based ceramic membrane on a surface of a porous substrate from a silica source and an aqueous alkaline solution (or an aqueous alkaline solution of an alumina source) comprises a pipe; a first cover member airtightly engaging one end of the pipe and having a projection protruding inward from an inner surface thereof; a second cover member airtightly engaging the other end of the pipe and having a projection protruding inward from an inner surface thereof; a support fixed to the projection of the first cover member for supporting the porous substrate; and a suspension container rotatably attached to the projection such that an open end of the suspension container is always directed substantially above.

The further feature of the second airtight vessel of the present invention is that when the airtight vessel is heated while rotating with the aqueous alkaline solution (or the aqueous alkaline solution of an alumina source) introduced into the pipe, with both cover members airtightly engaging both ends of the pipe such that the porous substrate engaging the support is fixed by both projections, and with the silica source charged into the suspension container, the silica source is vaporized without mixing with the aqueous alkaline solution (or the aqueous alkaline solution of an alumina source), and the aqueous alkaline solution (or the aqueous alkaline solution of an alumina source) is partly dropped onto the porous substrate while wetting the inner wall of the pipe, whereby the vaporized silica source reacts with the aqueous alkaline solution (or the aqueous alkaline solution of an alumina source) on the porous substrate to form the silicon oxide-based ceramic membrane. In the second airtight vessel of the present invention, it is preferable that a pair of ring-shaped internal flanges are disposed inside the pipe between both ends of the porous substrate and both cover members, and that the aqueous alkaline solution (or the aqueous alkaline solution of an alumina source) is placed between a pair of the ring-shaped internal flanges.

In the first airtight vessel, it is preferable that the support is a rod longitudinally extending in the center of the pipe beyond the porous substrate; that the projection of the cover member is a tubular projection; and that with the cover member airtightly engaging the open end of the pipe, a portion of the support extending from an end surface of the porous substrate is inserted into the tubular projection. An elastic gasket is preferably provided on the end surface of the tubular projection, thereby absorbing dimensional errors of the airtight vessel and the porous substrate in a state where the cover member airtightly engages the open end of the pipe. The tubular projection preferably comprises a first tubular projection integrally protruding from an inner surface of the cover member, a second tubular projection disposed slidably around the first tubular projection, and an elastic member disposed between the inner surface of the cover member and the second tubular projection, the end of the second tubular projection having a flange abutting the end surface of the porous substrate, and the flange being provided with an elastic gasket.

In the second airtight vessel, it is preferable that the support is a rod longitudinally extending in the center of the pipe beyond the porous substrate, that the projections of the cover members are tubular projections, and that with the cover members airtightly engaging the ends of the pipe, a portion of the support extending from an end surface of the porous substrate is inserted into the tubular projection. An elastic gasket is preferably provided on the end surface of each tubular projection, thereby absorbing dimensional errors of the airtight vessel and the porous substrate in a state where the cover members airtightly engage the ends of the pipe. At least one of the tubular projections comprises a first tubular projection integrally protruding from an inner surface of the cover member, a second tubular projection disposed slidably around the first tubular projection, and an elastic member disposed between the inner surface of the cover member and the second tubular projection, the end of the second tubular projection having a flange abutting the end surface of the porous substrate, and the flange being provided with an elastic gasket.

In the first and second airtight vessels, it is preferable that the projection comprises a stopper for the suspension container.

The first apparatus of the present invention for producing a silicon oxide-based ceramic membrane comprises a plurality of the above airtight vessels; a roller conveyor for transporting the airtight vessels while rotating; a heating furnace covering part of the roller conveyor; a supply station disposed on the roller conveyor upstream of the heating furnace for supplying the airtight vessels; and a cooling region and a takeout region of the airtight vessels disposed on the roller conveyor downstream of the heating furnace.

The second apparatus of the present invention for producing a silicon oxide-based ceramic membrane comprises a region for loading a porous substrate into each airtight vessel; a region for supplying a silica source and an aqueous alkaline solution (or an aqueous alkaline solution of an alumina source) into each airtight vessel; a region for heating the airtight vessels; a region for cooling the airtight vessels; and a region for taking the porous substrate out of each airtight vessel, in this order along the path of the airtight vessels.

The third apparatus of the present invention for producing a silicon oxide-based ceramic membrane comprises a plurality of rollers for rotating the airtight vessels, a frame having shelves each supporting the rollers rotatably, an endless chain engaging the rollers, and a means for driving the endless chain.

### BRIEF DESCRIPTION OF THE DRAWINGS

FIG. 1 is a cross-sectional view showing an example of the first airtight vessel of the present invention;

FIG. 2(a) is a perspective view showing an example of a suspension container disposed in an airtight vessel;

FIG. 2(b) is a cross-sectional view taken along the line C-C in FIG. 2(a);

FIG. 3(a) is a cross-sectional view showing a process of loading a porous substrate and an aqueous alkaline solution (or an aqueous alkaline solution of an alumina source) into the airtight vessel of FIG. 1;

FIG. 3(b) is a cross-sectional view showing a process of fixing a cover member provided with a suspension container containing a silica source to the airtight vessel of FIG. 1;

FIG. 4 is a cross-sectional view showing another example of the first airtight vessel of the present invention;

FIG. 5 is a cross-sectional view showing an example of the second airtight vessel of the present invention;

FIG. 6 is a partially enlarged schematic view showing an example of the first apparatus of the present invention;

FIG. 7 is a top view showing a roller conveyor in the first apparatus of the present invention;

FIG. 8 is a cross-sectional view showing a drive system attached to each roller of the roller conveyor;

FIG. 9(a) is an enlarged partial cross-sectional view taken along the line D-D in FIG. 8 showing the relationship between a rack, a pinion having a bearing, and a chain;

FIG. 9(b) is an enlarged partial cross-sectional taken along the line E-E in FIG. 8 showing the relationship between a chain and a pinion fixed to a shaft of the roller;

FIG. 10 is an exploded view showing the roller and its drive system;

FIG. 11 is a partial front view showing an end of the roller;

FIG. 12 is a schematic view showing an example of the second apparatus of the present invention;

FIG. 13 is a schematic view showing another example of the second apparatus of the present invention;

FIG. 14 is a front view showing an example of the third apparatus of the present invention;

FIG. 15(a) is a schematic view showing another example of the third apparatus of the present invention;

FIG. 15(b) is a schematic, cross-sectional view showing the arrangement of chains in the third apparatus of FIG. 15(a);

FIG. 16 is a schematic, cross-sectional view showing the autoclave containing the porous substrate and the starting materials in Example 1;

FIG. 17 is a chart showing the X-ray diffraction pattern of the zeolite membrane produced in Example 1;

FIG. 18 is a scanning electron photomicrograph showing the surface of the zeolite membrane produced in Example 1;

FIG. 19 is a scanning electron photomicrograph showing the section of the zeolite membrane produced in Example 1;

FIG. 20 is a chart showing the X-ray diffraction patterns of the zeolite membranes produced in Examples 3 and 4;

FIG. 21 is a scanning electron photomicrograph showing the surface of the zeolite membrane produced in Example 3;

FIG. 22 is a scanning electron photomicrograph showing the section of the zeolite membrane produced in Example 3; and

FIG. 23 is a scanning electron photomicrograph showing the surface of the zeolite membrane produced in Example 4.

### DETAILED DESCRIPTION OF THE PREFERRED EMBODIMENTS

[1] Starting Materials

In the present invention, the silicon oxide-based ceramic is an inorganic compound based on silicon oxide, specifically silica, zeolite containing a trace of aluminum, etc. The zeolite is generally an aluminosilicate, and may contain an alkaline metal such as sodium and potassium or an alkaline earth metal such as magnesium and calcium. The zeolite is a crystalline, inorganic, high-molecular compound having a skeleton where tetrahedrons of AlO₄ and SiO₄ are connected via a shared oxygen ion. For example, zeolite containing a cation of an alkaline metal or an alkaline earth metal has a composition described by the following general formula (1):

M_{x/n}[(AlO₂)ₓ(SiO₂)_{y}].wH₂O (1),

wherein M represents a cation of an alkaline metal or an alkaline earth metal, n represents the valence of the cation, w represents the number of water molecules per a unit lattice, and each of x and y represents the number of tetrahedrons per a unit lattice. The composition of zeolite free of the cation can be described by the general formula (1), in which x is 0. The silica is an amorphous material having a composition of SiO₂.wH₂O.

(1) Starting Materials for Zeolite Membrane

In the method of the present invention, a silica source and an aqueous alkaline solution of an alumina source are used as essential starting materials to produce a zeolite membrane.

(a) Silica Source

The silica source is vaporized and hydrolyzed at a temperature of preferably 25 to 250° C., more preferably 40 to 200° C., to produce a silicic acid or a silicate salt. When the vaporization temperature of the silica source is higher than 250° C., the internal pressure of the airtight vessel is excessively raised in the step of heating the airtight vessel. Specific examples of such silica sources include silicon alkoxides, etc. Preferred examples of the silicon alkoxides are tetraethoxysilane (tetraethylorthosilicate, Si(OC₂H₅)₄, TEOS) and tetramethoxysilane (tetramethylorthosilicate, Si(OCH₃)₄).

(b) Alumina Source

Usable as the alumina source are sodium aluminate, aluminum hydroxide, aluminum sulfate, metallic aluminum, aluminum isopropoxide, colloidal alumina, etc. The alumina source is preferably sodium aluminate. The alumina source is uniformly dissolved in the aqueous alkaline solution. The concentration of sodium aluminate in the aqueous alkaline solution is preferably 30% or less by mass, more preferably 0.1 to 20% by mass. When the concentration of sodium aluminate is more than 30% by mass, the sodium aluminate is excessively supplied onto the porous substrate surface in the gas phase reaction, resulting in a stoichiometrically unsuitable concentration ratio of the silica source to the alumina source for forming the zeolite. The aqueous alkaline solution may be alkalified by NaOH, KOH, etc. The concentration of the alkali such as NaOH is preferably 10% or less, more preferably 1 to 5% by mass.

The aqueous alkaline solution of the alumina source may contain a bulky basic compound such as tetrapropylammonium hydroxide, tetramethylammonium hydroxide, tetrabutylammonium hydroxide, and tetrapropylammonium bromide. The basic compound is preferably a weak base. The added basic compound is incorporated into the zeolite crystal such that the zeolite skeleton surrounds the basic compound, resulting in a stabilized zeolite structure. Further, because the basic compound incorporated into the crystal leads to the formation of a particular skeleton structure, the addition of the basic compound can selectively form a zeolite crystal with a desired structure and composition. The aqueous alkaline solution of the alumina source may contain a crystallization-accelerating agent such as amines, diamines, aminoalcohols, etc.

The aqueous alkaline solution of the alumina source preferably contains a fine zeolite powder as a seed crystal. The zeolite for use as the seed crystal may be selected from MFI, MEL, FAU, etc. depending on the desired skeleton structure.

(2) Starting Materials for Silica Membrane

A silica membrane can be formed from a silica source and an aqueous alkaline solution. Preferred examples of the silica source for the silica membrane may be the same as those for the zeolite membrane. The aqueous alkaline solution is preferably alkalified by NaOH, KOH, etc. The concentration of the alkali such as NaOH is preferably 10% or less, more preferably 1 to 5% by mass.

[2] Porous Substrate

The porous substrate is preferably composed of a ceramic, an organic high-molecular compound or a metal, more preferably a ceramic. Examples of the preferred ceramics include alumina, silica, titania and zirconia. Examples of the preferred metals include stainless steel, etc. To use the silicon oxide-based ceramic membrane formed on the porous substrate as a molecular sieve, the pore diameter of the porous substrate is preferably determined to meet the conditions that (a) the porous substrate firmly holds the silicon oxide-based ceramic membrane, that (b) pressure loss is minimized, and that (c) the porous substrate is sufficiently self-supported (with enough mechanical strength). Specifically, the pore diameter of the porous substrate may be approximately 0.02 to 2 μm, preferably 0.05 to 2 μm The porosity of the porous substrate is preferably 10 to 60%. The porous substrate is preferably in a tubular shape. Though not particularly restricted, the porous substrate may practically have a length of 2 to 200 cm, an inner diameter of 0.5 to 1 cm, and a thickness of 0.5 to 4 mm.

[3] Method for Producing Silicon Oxide-based Ceramic Membrane

Though the production of the silicon oxide-based ceramic membrane may be carried out with or without an alumina source in the aqueous alkaline solution in the present invention, the steps in both methods are essentially the same except for the existence of the alumina source. Thus, explanation will be made below on an example of using the alumina source to form the zeolite membrane. It should be noted, however, that the explanation may be applied to the case of using no alumina source.

(1) Application of aqueous alkaline solution to porous substrate

The aqueous alkaline solution of the alumina source is preferably applied to the porous substrate before the gas phase reaction. When the porous substrate is partly soaked in the aqueous alkaline alumina source solution, the porous substrate absorbs the alumina source solution by a capillary effect, whereby the solution is dispersed in the entire porous substrate. The zeolite seed crystal and/or the crystallization-accelerating agent contained in the aqueous alkaline alumina source solution are also dispersed in the porous substrate by the capillary effect. The porous substrate may be placed in the airtight vessel together with the silica source in a container, such that the porous substrate is partly soaked in the aqueous alkaline alumina source solution, or such that the aqueous alkaline alumina source solution is dropped onto the entire porous substrate. The airtight vessel is then sealed.

(2) Vaporization of Silica Source

The sealed airtight vessel is heated to vaporize the silica source. The heating temperature is equal to or higher than the vaporization temperature of the silica source, preferably 250° C. or lower, more preferably 200° C. or lower. The heating time may be changed depending on the predetermined thickness of the zeolite membrane. The heating time is generally a week or less, preferably 0.5 to 48 hours. The internal pressure of the airtight vessel increases by heating. The internal pressure is preferably 4 MPa or less, more preferably 2.5 MPa or less, from the viewpoint of the practical pressure resistance of the airtight vessel.

The silica source is vaporized at the heating temperature, and reacted with the alumina source in the aqueous alkaline solution on the surface of the porous substrate to form the zeolite membrane. Though the alumina source on the surface of the porous substrate is consumed in the gas phase reaction, the aqueous alkaline alumina source solution is constantly supplied to the surface by the capillary effect, etc. to continue the gas phase reaction in a case where the porous substrate is partly soaked in the aqueous alkaline alumina source solution, or a case where the aqueous alkaline alumina source solution is continually dropped on the porous substrate. Because the silica source is placed in the container such that it is not mixed with the aqueous alkaline alumina source solution, the silica source does not react with the alumina source in other portions than the surface of the porous substrate.

As described above, though the zeolite crystal structure changes in the liquor phase reaction as the concentrations of starting materials are changed in a mother liquor, the gas phase reaction used in the present invention does not have such disadvantage. In the method of the present invention, the concentration ratio of the silica source to the alumina source is kept approximately uniform during the gas phase reaction. Thus, the zeolite membrane produced by the method of the present invention has a uniform zeolite crystal structure and a uniform pore size.

The method of the present invention is applied for producing zeolite membranes with various compositions and/or crystal systems such as A-type zeolite, X-type zeolite, Y-type zeolite, ZSM-5 zeolite, faujasite, mordenite, ferrierite, etc.

[4] Airtight Vessel for Producing Silicon Oxide-based Ceramic Membrane

(1) First Airtight Vessel

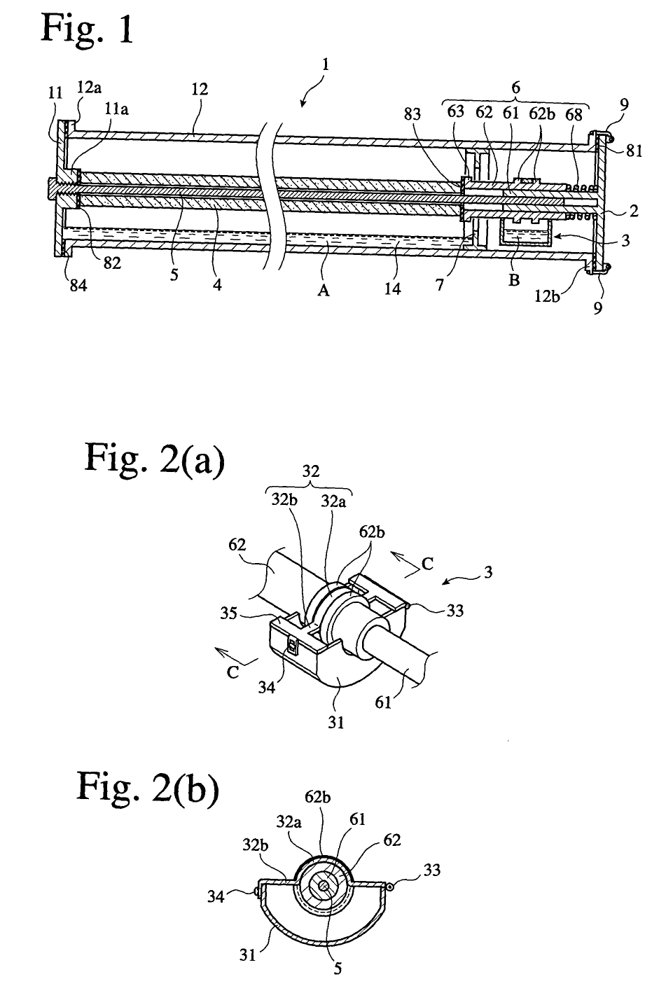

FIG. 1 shows an example of the first airtight vessel of the present invention. The airtight vessel 1 comprises a cylindrical pipe 12 having flanges 12a and 12b at both ends. A disc-shaped sealing member 11 is airtightly fixed to the flange 12a to provide the pipe 12 with a closed end. A cover member 2 is airtightly fixed to the flange 12b of the pipe 12 at an open end by a plurality of clamps 9 mounted onto the flange 12b or the cover member 2. The cover member 2 is detachable from the flange 12b by opening the clamps 9. The sealing member 11 may be integral with the pipe 12. Ring-shaped gaskets 84 and 81 are provided on the flanges 12a and 12b respectively to airtightly seal the airtight vessel 1.

The sealing member 11 has a tubular projection 11a protruding from a center of its inner surface inside the airtight vessel 1. A support 5 longitudinally protruding in the center of the airtight vessel 1 for supporting a porous substrate 4 is fixed to the tubular projection 11a.

A projection 6 protrudes from the inner surface of the cover member 2 at its center inside the airtight vessel 1. In this example, the projection 6 comprises an inner tube 61 (a first tubular part) vertically fixed to the inner surface of the cover member 2, and an outer tube 62 (a second tubular part) telescopically mounted on the inner tube 61. The inner tube 61 has an inner diameter larger than the outer diameter of the support 5, so that the tip portion of the support 5 is inserted into the inner tube 61. The outer tube 62 has a flange 63 at a front end, which comes into contact with the porous substrate 4. A couple of ring-shaped stoppers 62b are provided on the periphery of the outer tube 62, and a hanger of a suspension container 3 is held between the ring-shaped stoppers 62b. An elastic member 68 such as a spring is disposed around the inner tube 61 between the inner surface of the cover member 2 and the rear end of the outer tube 62. If a longitudinal dimensional error existed when the front end of the outer tube 62 comes into contact with the porous substrate 4, it would be absorbed by the deformation of the elastic member 68.

FIGS. 2(a) and 2(b) show an example of the suspension container 3. As shown in FIG. 2(a), the suspension container 3 comprises a semi-cylindrical container part 31 and a handle-like hanger 32 attached to the upper ends of the opposing side surfaces of the container part 31. The hanger 32 has a semicircular portion 32a and a pair of plane portions 32b each integrally connected to an end of the semicircular portion 32a. The inner diameter of the semicircular portion 32a is approximately equal to the outer diameter of the outer tube 62 of the projection 6. The hanger 32 has a hinge 33 between the upper end of the container part 31 and one plane portion 32b, and a clamp 34 between the upper end of the container part 31 and the other plane portion 32b. Thus, the hanger 32 can be opened and closed freely. To surely prevent the leakage of a silica source B from the suspension container 3, flanges 35 partly covering the opening of the container part 31 may be added to the plane portions 32b of the hanger 32 on the upper end of the container part 31.

As shown in FIG. 2(b), the semicircular portion 32a rotatably hangs from the projection 6 between the ring-shaped stoppers 62b. Thus, the silica source does not spill from the suspension container 3 always hanging from the projection 6, even when the airtight vessel (reaction vessel) 1 is rotated.

A ring-shaped internal flange 7 is disposed inside the pipe 12 at a position outside the flange 63, at which the ring-shaped internal flange 7 does not interfere with the suspension container 3. Though the ring-shaped internal flange 7 may be a flat ring plate having an outer diameter equal to the inner diameter of the pipe 12, the ring-shaped internal flange 7 may be constituted by a short, longitudinal ring portion having an outer diameter equal to the inner diameter of the pipe 12, and a transverse flat ring portion vertically protruding from the inner surface of the longitudinal ring portion, so that it easily attached to the pipe 12. The ring-shaped internal flange 7 may be fixed to the pipe 12 by shrinkage fit, welding, etc.

When the porous substrate 4 is attached to the support 5 and the open end of the pipe 12 is closed by the cover member 2, both ends of the porous substrate 4 are fixed by the tubular projection 11a and the flange 63. As shown in FIG. 1, ring-shaped, elastic gaskets 82 and 83 are provided on the end surfaces of the tubular projection 11a and the flange 63, whereby there is no likelihood of damaging the end surfaces of the porous substrate 4. The elastic gaskets 82 and 83 can absorb a dimensional error of the airtight vessel 1 and the porous substrate 4 together with the elastic member 68. The elastic gaskets 82 and 83 are preferably made of a silicone rubber, a fluorine rubber, etc. from the viewpoint of heat resistance and chemical resistance.

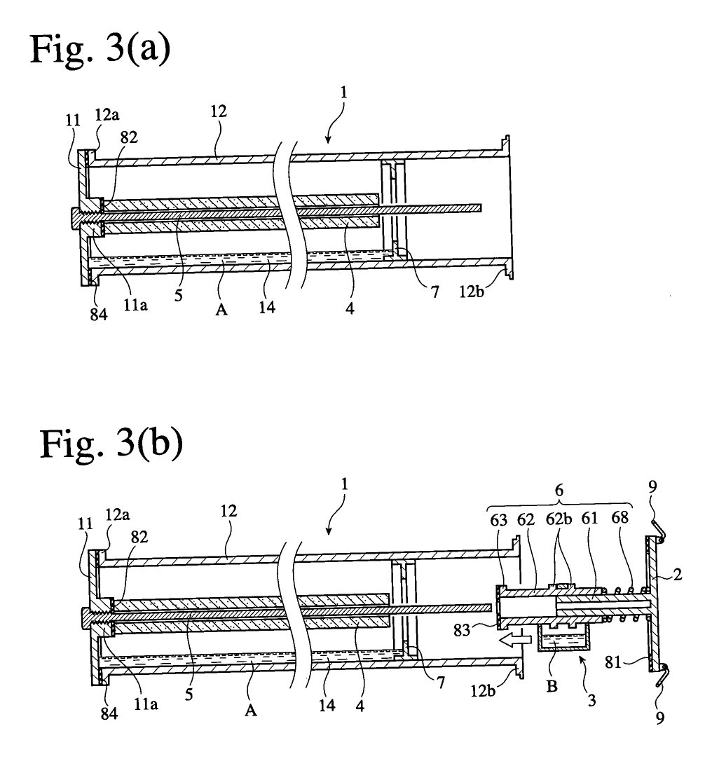

FIGS. 3(a) and 3(b) show an example of the use of the airtight vessel 1. As shown in FIG. 3(a), the porous substrate 4 is fitted to the support 5, and an aqueous alkaline alumina source solution A is put in a fluid reservoir 14 between the ring-shaped internal flange 7 and the sealing member 11. As shown in FIG. 3(b), the suspension container 3 containing a silica source B in the container part 31 is then suspended from the projection 6 between the ring-shaped stoppers 62b, and the cover member 2 is airtightly fixed to the flange 12b of the pipe 12. Thus, both ends of the porous substrate 4 come into contact with the tubular projection 11a and the flange 63 via the elastic gaskets 82 and 83, with the tip portion of the support 5 inserted into the inner tube 61 of the projection 6. In a case where there are dimensional errors in the airtight vessel 1 and the porous substrate 4, the elastic member 68 and the elastic gaskets 82 and 83 absorb the errors. Under this condition, the porous substrate 4 does not touch the aqueous alkaline alumina source solution A and the silica source B, and the aqueous alkaline alumina source solution A does not comes into contact with the silica source B.

When the airtight vessel 1 is heated while being laid horizontally and rotated, the silica source B is vaporized, and the aqueous alkaline alumina source solution A is partly dropped onto the porous substrate 4 while wetting the inner wall of the pipe 12. Thus, the silica source B is hydrolyzed on the porous substrate 4 wet with the aqueous alkaline alumina source solution A, and reacts with the alumina source, to form a zeolite membrane.

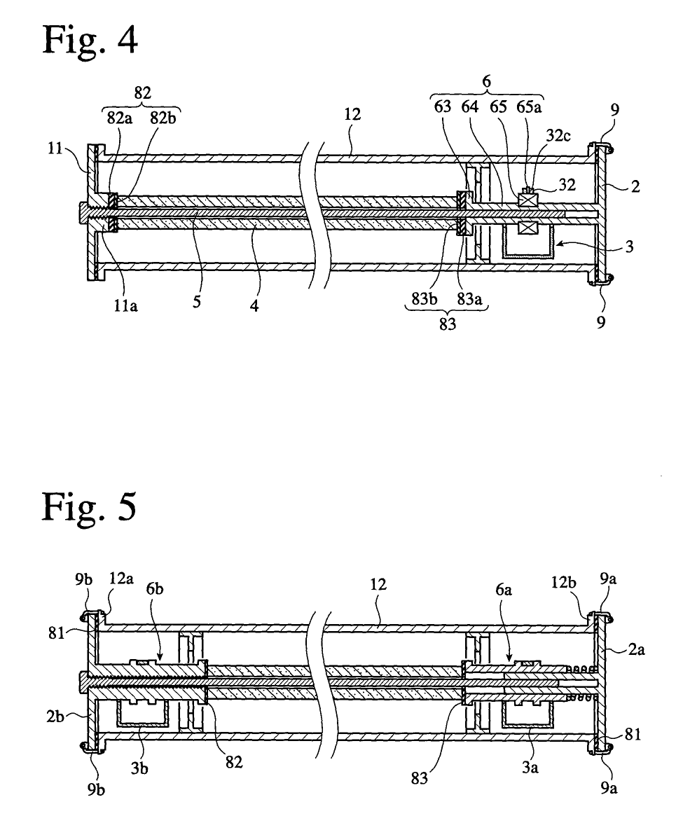

FIG. 4 shows another example of the first airtight vessel of the present invention. Because the airtight vessel of FIG. 4 shares basic features with that of FIG. 1, only the differences are described below. A projection 6 comprises a tubular part 64 protruding from a cover member 2 at a center, a bearing 65 disposed on the periphery of the tubular part 64, and a flange 63 provided at the end of the tubular part 64. The bearing 65 has a protrusion 65a on an outer surface. A hanger 32 of a suspension container 3 has an opening 32c. The protrusion 65a is fitted into the opening 32c to support the suspension container 3 rotatably. Because the inner diameter of the hanger 32 is larger than the outer diameter of the flange 63, the suspension container 3 can pass the flange 63 to be fixed to the bearing 65.

Elastic gaskets 82 and 83 on a tubular projection 11a and the flange 63 are composed of two materials having different elasticity. For example, as shown in FIG. 4, each elastic gasket 82, 83 has a soft portion 82a, 83a made of a soft rubber, etc. and a hard portion 82b, 83b made of a hard rubber, etc. in this order from the tubular projection 11a and the flange 63, respectively. Thus, a porous substrate 4 comes into contact with the hard portions 82b and 83b, so that the porous substrate 4 is hardly buried in the elastic gaskets 82 and 83.

(2) Second Airtight Vessel

FIG. 5 shows an example of the second airtight vessel of the present invention. The airtight vessel of FIG. 5 is the same as the airtight vessel of FIG. 1 except that cover members 2a and 2b are attached to both ends of a pipe 12. Thus, only differences are described below. The cover members 2a and 2b are detachably and airtightly fixed to the pipe 12 by clamps 9a and 9b. The cover members 2a and 2b may have the same shape as that of the cover member 2 shown in FIG. 1. Suspension containers 3a and 3b hang from tubular projections 6a and 6b, respectively, and the cover members 2a and 2b are airtightly attached to the flanges 12a and 12b of the pipe 12 containing an aqueous alkaline alumina source solution A by the clamps 9a and 9b, respectively. This airtight vessel may be used in the same manner as shown in FIGS. 3(a) and 3(b).

[5] Apparatus for Producing Silicon Oxide-based Ceramic Membrane

(1) First Example

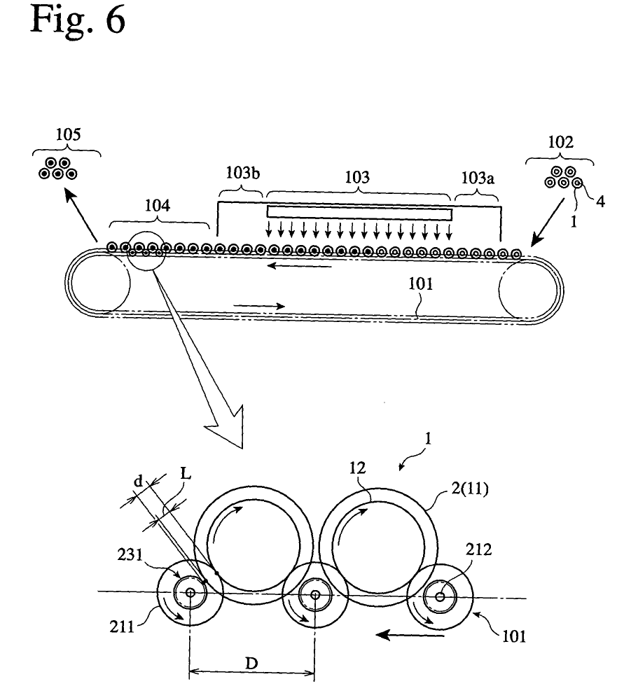

FIG. 6 shows an example of the first apparatus of the present invention for producing a silicon oxide-based ceramic membrane. In FIG. 6, “∘” represents a porous substrate 4 without a silicon oxide-based ceramic membrane, and “●” represents a porous substrate, on which the silicon oxide-based ceramic membrane is formed. The apparatus of FIG. 6 comprises an endless roller conveyor 101 for rotating and transporting airtight vessels 1 horizontally, a heating furnace 103 covering part of the roller conveyor 101, a supply station 102 for supplying the airtight vessels 1 to the conveyor 101, a cooling region 104 for cooling the airtight vessels 1 on the conveyor 101, and a takeout station 105 for collecting the airtight vessels 1. The supply station 102 is disposed on the roller conveyor 101 upstream of the heating furnace 103, and the cooling region 104 and the takeout station 105 are disposed on the roller conveyor 101 downstream of the heating furnace 103.

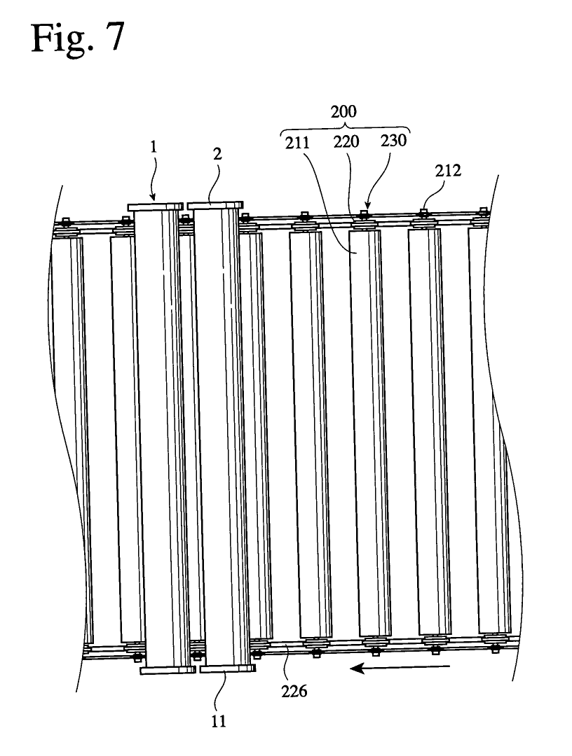

As shown in FIGS. 6 and FIG. 7, the roller conveyor 101 comprises a plurality of parallel rollers 211 moving while rotating, rotors 220 rotatably supporting both ends of a shaft 212 of each roller 211, and a drive system 230 for each roller 211 and each rotor 220.

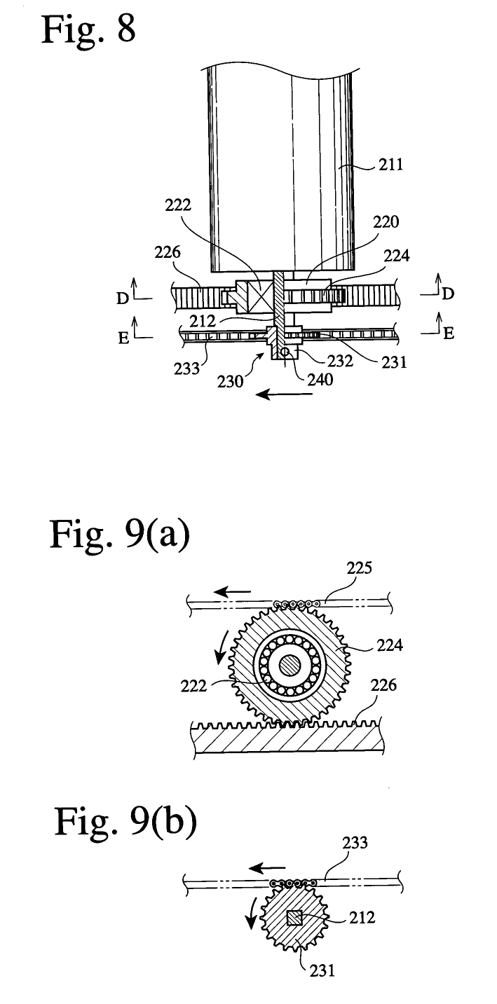

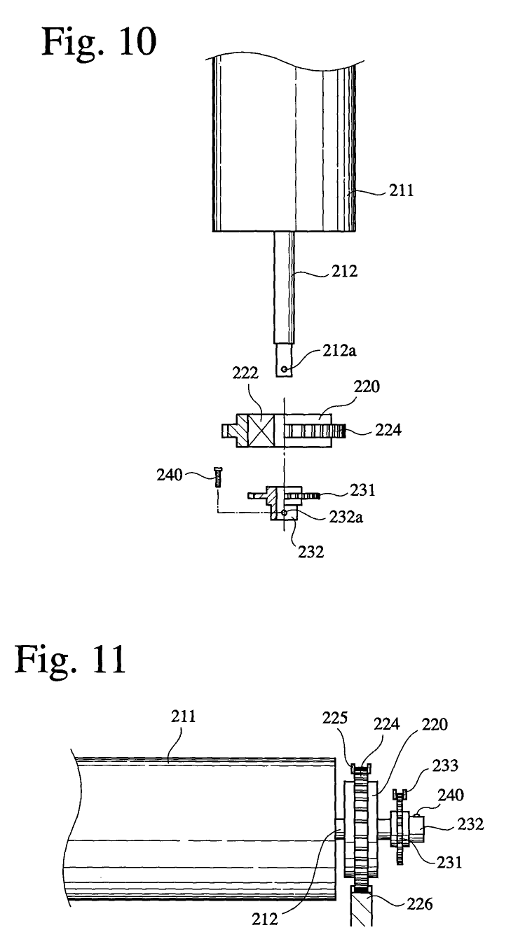

FIGS. 8 to 11 show the details of each rotor 220 and the drive system 230 attached thereto. The rotor 220 has a pinion 224 rotatably mounted to the shaft 212 of the roller 211 via a bearing 222. The pinion 224 is preferably thick because a load of the roller 211 is applied to the pinion 224. The shaft 212 has a tip portion with a square cross section. The gear 231 is fixed to the square cross-sectioned tip portion of the shaft 212 by a screw 240, which is fitted into a threaded hole 212a of the shaft 212 and a threaded hole 232a of a hub 232.

As shown in FIG. 9(a), because the pinion 224 engages an upper chain 225 and a lower rack (linear toothed member) 226, the chain 225 moves the pinion 224 along the rack 226 while rotating. The shaft 212 is rotatably supported by the bearing 222. As shown in FIG. 9(b), the gear 231 engages with an upper chain 233. Though FIG. 8 shows the chain 233 below the gear 231 for the clarity of depiction, the chain 233 is actually disposed above the gear 231 as shown in FIG. 9(b). The pinion 224, the gear 231 and the chains 225 and 233 constitute the drive system 230.

As shown in FIGS. 6 and 7, each airtight vessel 1 is placed between adjacent rollers 211. The cover member 2 and the sealing member 11 of the airtight vessel 1 slightly project outside the ends of the rollers 211. As shown in the enlarged view of FIG. 6, the distance D between the centers of the adjacent rollers 211 is slightly longer than the diameter of the cover member 2 and that of the sealing member 11, so that adjacent airtight vessels 1 do not come into contact with each other. Further, to prevent the airtight vessel 1 from interfering with the drive system 230, the length L of flange portions of the cover member 2 and the sealing member 11 is smaller than the difference d between the outer diameter of the gear 231 and the outer diameter of the roller 211.

In this apparatus of the present invention, the moving speed of the rollers 211 is remarkably smaller than the rotating speed thereof. The rotating speed and the moving speed of the rollers 211 should be independently controlled. Thus, the chain 233 engaging the gear 231 fixed to the shaft 212 of the roller 211 moves at a high speed, while the chain 225 engaging the pinion 224 fixed to the rotor 220 moves at a low speed. When the chain 233 moves, the roller 211 rotatably supported by the rotor 220 via the bearing 222 rotates freely. When the chain 225 moves, the rotor 220 having the pinion 224 moves while rotating, whereby the shaft 212 moves along the conveyor 101 to transport the roller 211. Thus, the rollers 211 are rotated by the chain 233 and transported by the chain 225, whereby the roller 211 slowly moves while rotating at a high speed.

The heating furnace 103 may use a heating medium such as heated air or a heat source such as an electric heater. It is not preferred that the airtight vessels 1 are rapidly heated or cooled, because the porous substrates 4 made of ceramics, etc. are likely to be cracked. It is thus preferable that a preheating region 103a is disposed upstream of the heating furnace 103, and that a slow-cooling region 103b is disposed downstream of the heating furnace 103. The length of the heating furnace 103 may be adjusted depending on the desired heating time. In the cooling region 104, the airtight vessels 1 are left to stand in the air for cooling.

The production of the silicon oxide-based ceramic membrane using the apparatus shown in FIG. 6 is described below. The airtight vessels 1 are preferably rotated at such a rotating speed that the inner surface of each airtight vessel 1 is wet with the aqueous alkaline alumina source solution A, and that the aqueous alkaline alumina source solution A is dropped onto the porous substrate 4 little by little. The rotating speed of the airtight vessels 1 is preferably 0.5 to 10 rpm, more preferably 1 to 3 rpm.

After the silicon oxide-based ceramic membrane is formed on each porous substrate 4 and the airtight vessels 1 are cooled, the airtight vessels 1 are removed from the roller conveyor 101. With the airtight vessels 1 laid horizontally, the clamps 9 are opened to take out the porous substrates 4 from the airtight vessels 1. In the case of repeatedly producing silicon oxide-based ceramic membranes on porous substrates 4 in the same airtight vessels 1, a fresh aqueous alkaline alumina source solution A, a fresh silica source B and fresh porous substrates 4 are put into the airtight vessels 1 again, and the airtight vessels 1 are placed on the roller conveyor 101 in the supply station 102.

(2) Second Example

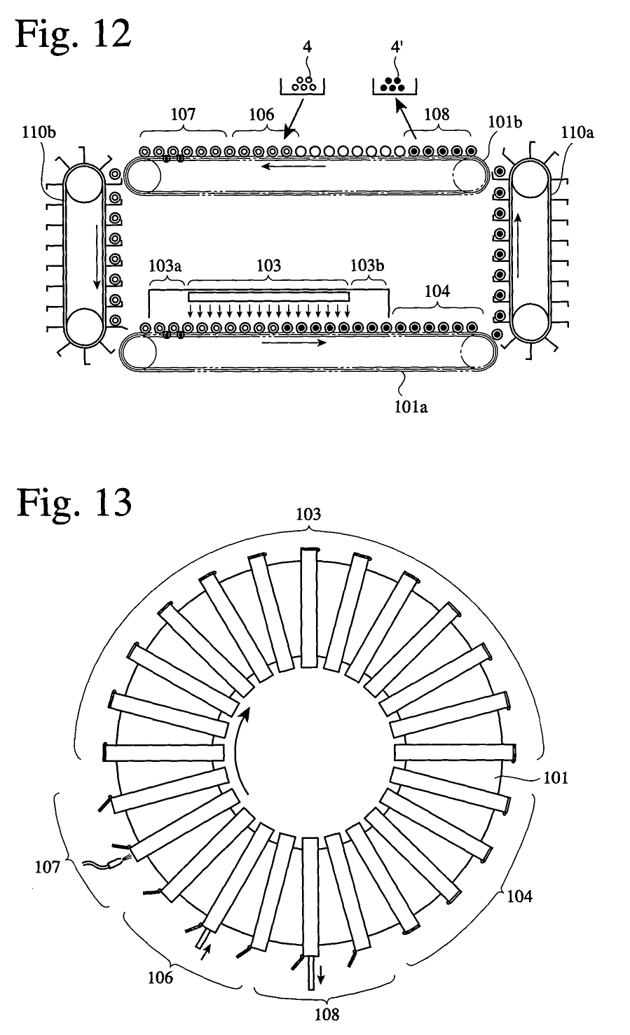

FIG. 12 shows an example of the second apparatus of the present invention for producing the silicon oxide-based ceramic membrane. The apparatus of FIG. 12 comprises a roller conveyor 101a with a heating furnace 103, a perpendicular transport conveyor 110a disposed downstream of the roller conveyor 101a, a horizontal roller conveyor 101b disposed downstream of the perpendicular transport conveyor 110a, and a perpendicular transport conveyor 110b disposed downstream of the horizontal roller conveyor 101b. Because an end of the transport conveyor 110b is adjacent to an end of the roller conveyor 101a, the airtight vessels 1 are endlessly transported by the entire apparatus. The roller conveyor 101a and the heating furnace 103 of this apparatus are the same as those of the first example, whereby explanation thereof is omitted. Each of the transport conveyors 110a and 110b comprises an endless belt having carriers for the airtight vessels 1, to deliver the airtight vessels 1 with the roller conveyor 101a and the roller conveyor 101b. As shown in FIG. 12, provided on the roller conveyor 101b are a region 106 for loading the porous substrate 4 into each airtight vessel 1, a region 107 for supplying the starting materials into each airtight vessel 1, and a region 108 for taking the porous substrate 4′ having the silicon oxide-based ceramic membrane out of each airtight vessel 1. In the apparatus of FIG. 12, the steps of loading the porous substrate 4 and the starting materials into each airtight vessel 1 and taking the porous substrate 4′ out of each airtight vessel 1 can be successively carried out while rotating and transporting the airtight vessels 1 without being taken out from the roller conveyor 101b.

The second apparatus of the present invention may have a structure shown in FIG. 13, in which the airtight vessels 1 are radially placed on a circular roller conveyor 101, and transported around the center of the radial arrangement.

(3) Third Example

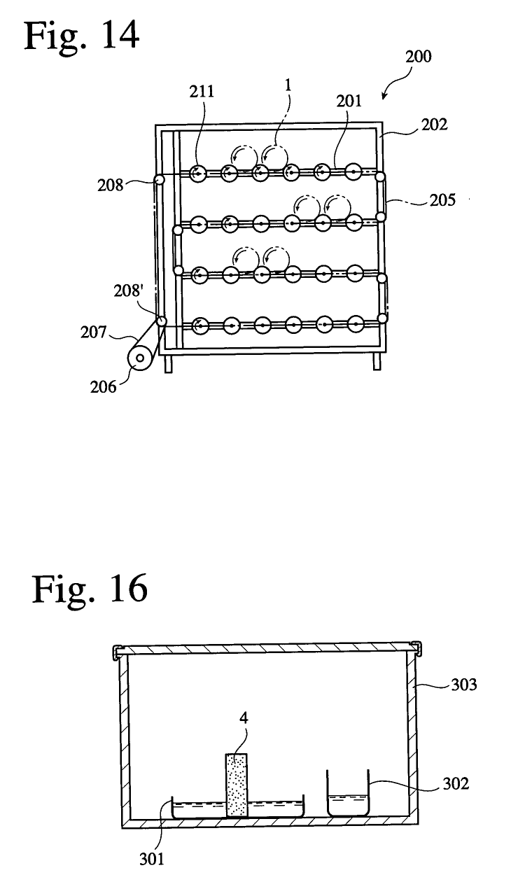

The apparatus of the present invention is not necessarily restricted to carry out continuous operation, but may be a batch-type apparatus. FIG. 14 shows an example of the batch-type apparatus of the present invention, in which a plurality of rotating airtight vessels 1 are heated in a heating furnace at the same time. In the apparatus of FIG. 14, a frame 200 comprises vertical supports 202, a plurality of horizontal shelves 201 fixed to the support 202, and a plurality of rollers 211 rotatably supported by each shelf 201. A gear-(not shown) mounted to one end of each roller 211 engages an endless chain 205 extending along all the shelves 201 via pulleys 208 mounted to the vertical supports 202. The gear of each roller 211 is rotated by the chain 205. One pulley 208′ is driven by an external driving means 206 via another chain 207. When the driving means 206 is activated, the rollers 211 are rotated by the chains 205 and 207, so that the airtight vessels 1 placed between adjacent rollers 211 are also rotated.

(4) Forth Example

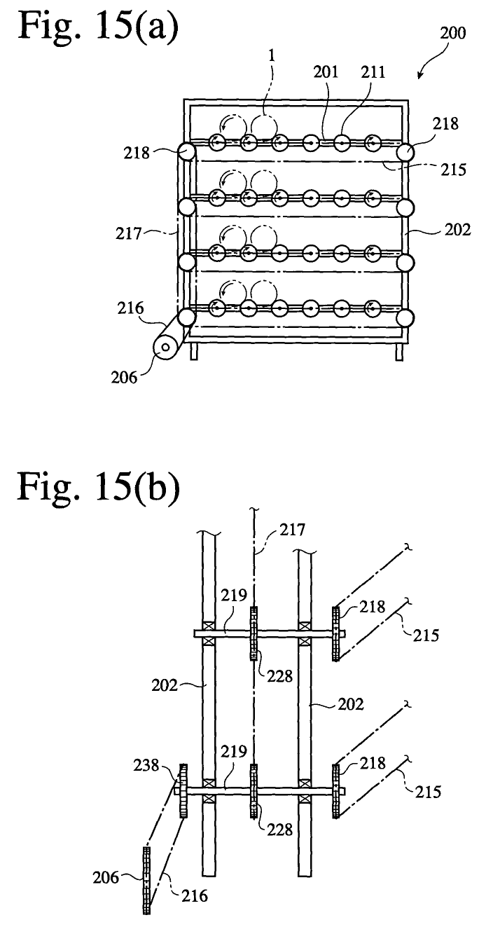

FIGS. 15(a) and 15(b) show another example of the batch-type apparatus of the present invention. The apparatus of FIGS. 15(a) and 15(b) is basically the same as the third example except for the arrangement of chains. Therefore, only differences are described below. Each first endless chain 215 engages a pair of pulleys 218, 218 mounted to vertical supports 202, 202, to rotate rollers 211 disposed on a shelf 201. A shaft 219 of a pulley 218 for each first chain 215 is provided with a pulley 228 engaging a second chain 217. Thus, the second chain 217 moves the first chains 215. One shaft 219 of a pulley 218 is further provided with a pulley 238, which moves by an external driving device 206 via a third chain 216. When the driving device 206 is activated, the rollers 211 are rotated by the chains 215, 216 and 217, so that the airtight vessels 1 placed between adjacent rollers 211 are also rotated.

The present invention will be explained in more detail referring to Examples below without intention of restricting the present invention thereto.

### Example 1

An aqueous solution containing 1.3 parts by weight of a 1-M aqueous tetrapropylammonium hydroxide solution (available from Aldrich Chemical Company, Inc.) and 7.65 parts by weight of distilled water was put in a dish 301. A tubular α-alumina substrate 4 having a length of 2.5 cm, an inner diameter of 0.8 cm, a thickness of 2 mm, and a pore diameter of 0.2 to 1 μm (available from NGK Insulators, Ltd.) was partly soaked in the aqueous solution. As schematically shown in FIG. 16, the dish 301 and a beaker 302 containing 2.0 g of tetraethylorthosilicate (TEOS, purity: 98%) were placed in an autoclave 303. The autoclave 303 was airtightly closed and heated at 165° C. for 44 hours, to form a zeolite membrane on the α-alumina substrate.

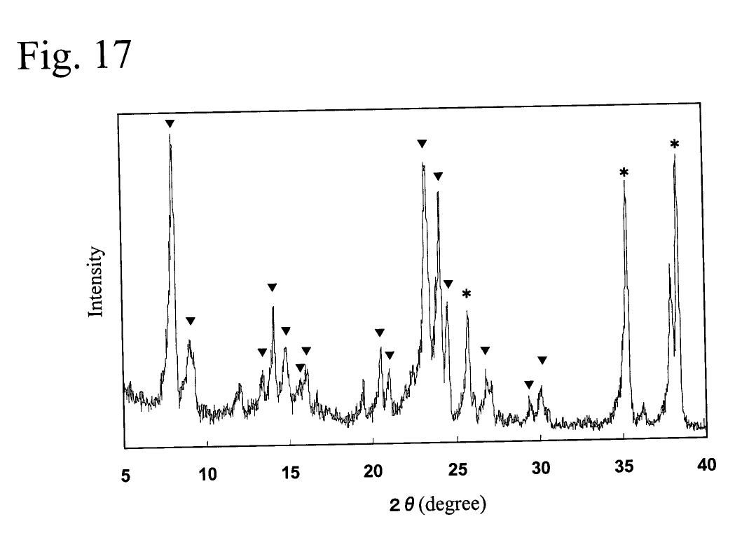

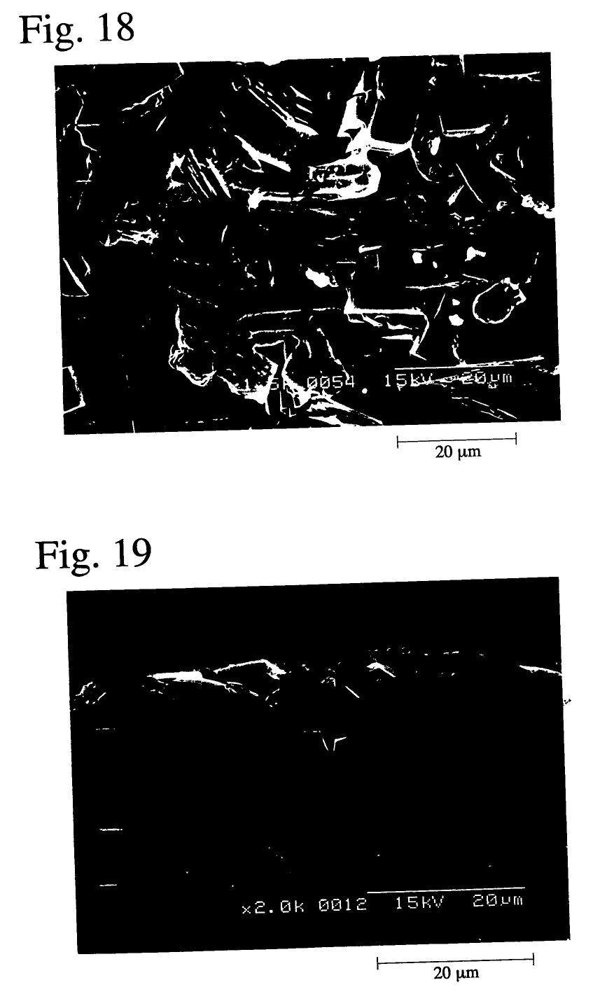

The X-ray diffraction pattern of the resultant zeolite membrane is shown in FIG. 17, in which “▾” represents peaks of MFI-type zeolite, and “*” represents peaks of α-alumina constituting the substrate 4. The scanning electron photomicrographs of the surface and section of the zeolite membrane are shown in FIGS. 18 and 19, respectively. The zeolite membrane of Example 1 had fine pores with a uniform size like membranes produced by the hydrothermal synthesis.

### Examples 2 to 4

A tubular α-alumina substrate having a length of 80 cm, an outer diameter of 10 mm, an inner diameter of 6 to 7 mm and a pore diameter of 200 nm to 1 μm (available from Noritake Co., Ltd.) was fitted to the support of the airtight vessel 1 shown in FIG. 1. Each aqueous alkaline alumina source solution shown in Table 1 was prepared using sodium aluminate containing 31 to 35% by weight of Na₂O and 34 to 39% by weight of Al₂O₃ with a Na₂O/Al₂O₃ mole ratio of 1.5 (available from Kanto Kagaku) as an alumina source, and charged into the fluid reservoir 14 of the airtight vessel 1. 72 g of tetraethoxysilane (TEOS) was charged into the suspension container 3 of each airtight vessel 1 as a silica source, and each vessel 1 was airtightly closed.

TABLE 1

| | Aqueous Alkaline Alumina Source Solution | | | | Amount |
|---|---|---|---|---|---|
| | Composition (parts by weight) | | | Amount | of TEOS |
| No. | NaAlO₂ | NaOH | Distilled Water | (g) | (g) |
| Example 2 | 0.28 | 0.68 | 10.8 | 275 | 72 |
| Example 3 | 0.28 | 0.68 | 10.8 | 275 | 72 |
| Example 4 | 1.39 | 0.34 | 10.9 | 275 | 72 |

Each airtight vessel 1 was heated while rotating at 5 rpm to form a zeolite membrane on the α-alumina substrate. The crystal system of each zeolite membrane was evaluated by X-ray diffraction and scanning electron microscopy. The reaction time, the reaction temperature and the crystal system of each zeolite membrane are shown in Table 2.

TABLE 2

| | Reaction Time | Reaction Temperature | Crystal System of |
|---|---|---|---|
| No. | (hour) | (° C.) | Zeolite Membrane |
| Example 2 | 23 | 100 | A-type, Faujasite |
| Example 3 | 64 | 90 | A-type, Faujasite |
| Example 4 | 64 | 100 | A-type |

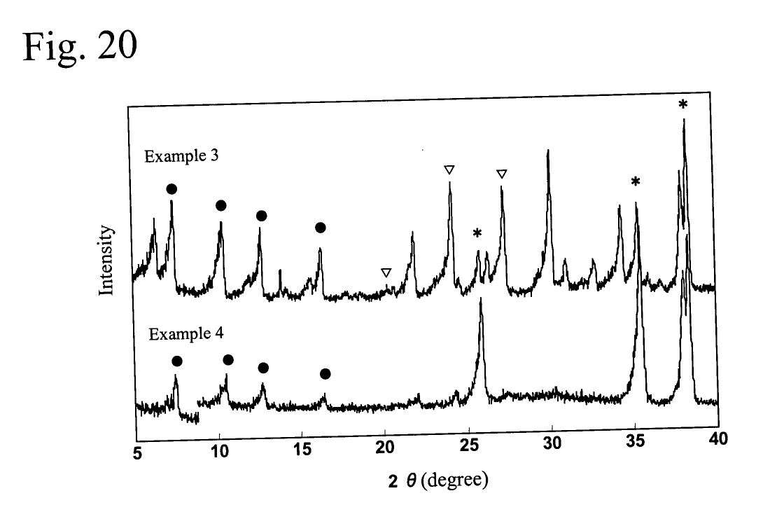

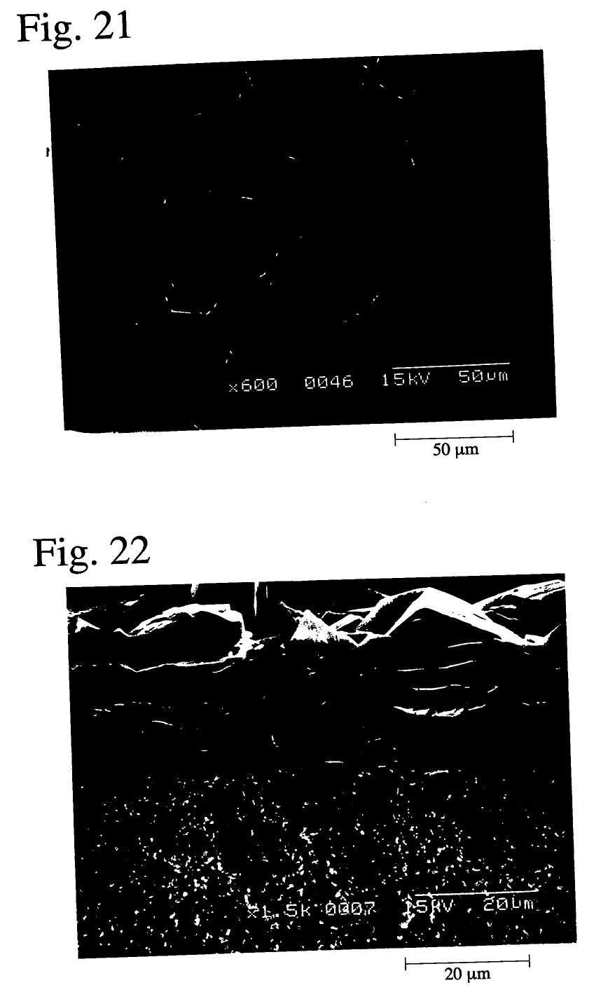

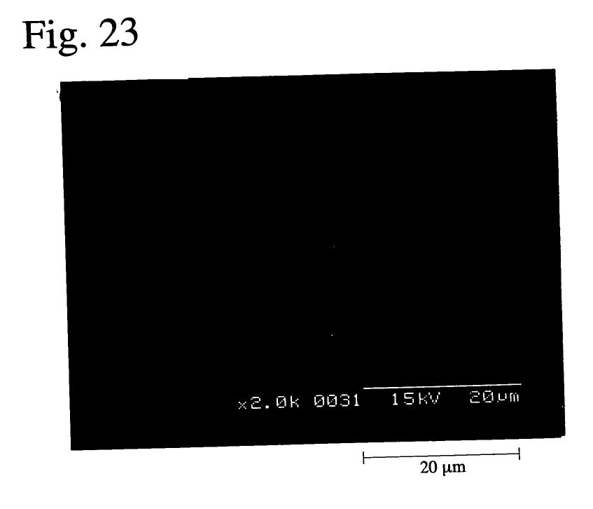

The X-ray diffraction patterns of the zeolite membranes of Examples 3 and 4 are shown in FIG. 20. In FIG. 20, “∇” represents peaks of faujasite, “●” represents peaks of A-type zeolite, and “*” represents peaks of α-alumina constituting the substrate. The scanning electron photomicrographs of the surface and section of the zeolite membrane produced in Example 3 are shown in FIGS. 21 and 22, respectively. The scanning electron photomicrograph of the surface of the zeolite membrane produced in Example 4 is shown in FIG. 23. The zeolite membranes of Examples 2 to 4 were fine porous membranes with a uniform pore size like the membrane of Example 1.

As described in detail above, in the method of the present invention, a silica source and an aqueous alkaline solution (or an aqueous alkaline solution of an alumina source) are heated without mixing with each other in an airtight vessel, so that a silicon oxide-based ceramic membrane is formed on a porous substrate by a gas phase reaction. Thus, the silicon oxide-based ceramic membrane with a uniform composition can be uniformly formed at an easily controlled thickness on the surface of the porous substrate. Because the silicon oxide-based ceramic membranes produced by the method of the present invention have pores with a uniform size, they are applied for molecular sieves for separating various gases or liquors.

The airtight vessel of the present invention can effectively form the silicon oxide-based ceramic membrane, because the porous substrate is kept wet with the aqueous alkaline solution (or the aqueous alkaline solution of the alumina source), and because the vaporized silica source interacts with the solution on the porous substrate in the vessel. The apparatus of the present invention can rotate and heat a plurality of airtight vessels successively or simultaneously, thereby forming the silicon oxide-based ceramic membranes on a lot of porous substrates with high efficiency.

What is claimed is:

1. A method for producing a silicon oxide-based ceramic membrane on a surface of a porous substrate from a silica source and an aqueous alkaline solution (or an aqueous alkaline solution of an alumina source) by a gas phase reaction, comprising the step of heating said silica source and said aqueous alkaline solution (or said aqueous alkaline solution of an alumina source) in an airtight vessel without mixing them.

2. The method for producing a silicon oxide-based ceramic membrane according to claim 1, wherein said aqueous alkaline solution (or said aqueous alkaline solution of an alumina source) is put onto said porous substrate before said gas phase reaction.

3. The method for producing a silicon oxide-based ceramic membrane according to claim 1, wherein a seed crystal of a silicon oxide-based ceramic and/or a crystallization-accelerating agent are deposited onto said porous substrate before said gas phase reaction.

4. The method for producing a silicon oxide-based ceramic membrane according to claim 1, wherein said gas phase reaction is carried out at a temperature of 250° C. or lower.

5. The method for producing a silicon oxide-based ceramic membrane according to claim 1, wherein said gas phase reaction is carried out under a pressure (gauge pressure) of 4 MPa or less.

6. The method for producing a silicon oxide-based ceramic membrane according to claim 1, wherein said porous substrate is made of a ceramic, an organic high-molecular compound or a metal.

7. The method for producing a silicon oxide-based ceramic membrane according to claim 1, wherein said silica source is a silicon compound that is vaporized and hydrolyzed at a temperature equal to or lower than said gas phase reaction temperature, or a silicon compound that reacts with an aluminum compound to form an aluminosilicate at a temperature equal to or lower than said gas phase reaction temperature.

8. The method for producing a silicon oxide-based ceramic membrane according to claim 7, wherein said silica source is a silicon alkoxide.

9. The method for producing a silicon oxide-based ceramic membrane according to claim 8, wherein said silica source is tetraethoxysilane or tetramethoxysilane.

10. The method for producing a silicon oxide-based ceramic membrane according to claim 1, wherein said alumina source is sodium aluminate, aluminum hydroxide, aluminum sulfate, metallic aluminum, aluminum isopropoxide or colloidal alumina.

11. The method for producing a silicon oxide-based ceramic membrane according to claim 10, wherein said alumina source is sodium aluminate.

12. The method for producing a silicon oxide-based ceramic membrane according to claim 1, wherein said aqueous alkaline solution (or said aqueous alkaline solution of an alumina source) contains a seed crystal of a silicon oxide-based ceramic and/or a crystallization-accelerating agent.

13. A method for producing a silicon oxide-based ceramic membrane on a surface of a porous substrate, comprising placing said porous substrate, a silica source and an aqueous alkaline solution in an airtight vessel, such that said silica source is not mixed with said aqueous alkaline solution; keeping a surface of said porous substrate wet with said aqueous alkaline solution; raising the internal temperature of said airtight vessel to a temperature equal to or higher than the vaporization temperature of said silica source to vaporize said silica source, thereby causing said silica source to react with said aqueous alkaline solution on said porous substrate to form said silicon oxide-based ceramic membrane.

14. The method for producing a silicon oxide-based ceramic membrane according to claim 13, wherein said silicon oxide-based ceramic membrane is made of silica.

15. A method for producing a silicon oxide-based ceramic membrane on a surface of a porous substrate, comprising placing said porous substrate, a silica source and an aqueous alkaline solution of an alumina source in an airtight vessel, such that said silica source is not mixed with said aqueous alkaline solution of an alumina source; keeping a surface of said porous substrate wet with said aqueous alkaline solution of an alumina source; raising the internal temperature of said airtight vessel to a temperature equal to or higher than the vaporization temperature of said silica source to vaporize said silica source, thereby causing said silica source to react with said aqueous alkaline solution of an alumina source on said porous substrate to form said silicon oxide-based ceramic membrane.

16. The method for producing a silicon oxide-based ceramic membrane according to claim 15, wherein said silicon oxide-based ceramic membrane is made of zeolite.

17. An airtight vessel for producing a silicon oxide-based ceramic membrane on a surface of a porous substrate from a silica source and an aqueous alkaline solution (or an aqueous alkaline solution of an alumina source), comprising a pipe having a closed end and an open end; a support fixed to said closed end of said pipe and protruding inward from an inner surface thereof; a cover member airtightly engaging said open end of said pipe; a projection protruding inward from an inner surface of said cover member for fixedly supporting said porous substrate; and a suspension container rotatably attached to said projection such that an open end of said suspension container is always directed substantially above; wherein when said airtight vessel is heated while rotating with said aqueous alkaline solution (or said aqueous alkaline solution of an alumina source) introduced into said pipe, with said cover member airtightly engaging said open end of said pipe such that said porous substrate engaging said support is fixed by said projection, and with said silica source charged into said suspension container, said silica source is vaporized without mixing with said aqueous alkaline solution (or said aqueous alkaline solution of an alumina source), and said aqueous alkaline solution (or said aqueous alkaline solution of an alumina source) is partly dropped onto said porous substrate while wetting the inner wall of said pipe, whereby the vaporized silica source reacts with said aqueous alkaline solution (or said aqueous alkaline solution of an alumina source) on said porous substrate to form said silicon oxide-based ceramic membrane.

18. The airtight vessel according to claim 17, wherein a ring-shaped internal flange is disposed inside said pipe between an end surface of said porous substrate and said cover member, and said aqueous alkaline solution (or said aqueous alkaline solution of an alumina source) is placed between said closed end of said pipe and said ring-shaped internal flange.

19. The airtight vessel according to claim 17, wherein said support is a rod longitudinally extending in the center of said pipe beyond said porous substrate; wherein said projection of said cover member is a tubular projection; and wherein with said cover member airtightly engaging said open end of said pipe, a portion of said support extending from an end surface of said porous substrate is inserted into said tubular projection.

20. The airtight vessel according to claim 19, wherein an elastic gasket is provided on the end surface of said tubular projection, thereby absorbing dimensional errors of said airtight vessel and said porous substrate in a state where said cover member airtightly engages said open end of said pipe.

21. The airtight vessel according to claim 19, wherein said tubular projection comprises a first tubular projection integrally protruding from an inner surface of said cover member, a second tubular projection disposed slidably around said first tubular projection, and an elastic member disposed between the inner surface of said cover member and said second tubular projection, the end of said second tubular projection having a flange abutting the end surface of said porous substrate, and said flange being provided with an elastic gasket.

22. The airtight vessel according to claim 17, wherein said projection comprises a stopper for said suspension container.

23. An airtight vessel for producing a silicon oxide-based ceramic membrane on a surface of a porous substrate from a silica source and an aqueous alkaline solution (or an aqueous alkaline solution of an alumina source), comprising a pipe; a first cover member airtightly engaging one end of said pipe and having a projection protruding inward from an inner surface thereof; a second cover member airtightly engaging the other end of said pipe and having a projection protruding inward from an inner surface thereof; a support fixed to the projection of said first cover member for supporting said porous substrate; and a suspension container rotatably attached to said projection such that an open end of said suspension container is always directed substantially above; wherein when said airtight vessel is heated while rotating with said aqueous alkaline solution (or said aqueous alkaline solution of an alumina source) introduced into said pipe, with both cover members airtightly engaging both ends of said pipe such that said porous substrate engaging said support is fixed by both projections, and with said silica source charged into said suspension container, said silica source is vaporized without mixing with said aqueous alkaline solution (or said aqueous alkaline solution of an alumina source), and said aqueous alkaline solution (or said aqueous alkaline solution of an alumina source) is partly dropped onto said porous substrate while wetting the inner wall of said pipe, whereby the vaporized silica source reacts with said aqueous alkaline solution (or said aqueous alkaline solution of an alumina source) on said porous substrate to form said silicon oxide-based ceramic membrane.

24. The airtight vessel according to claim 23, wherein a pair of ring-shaped internal flanges are disposed inside said pipe between both ends of said porous substrate and both cover members, and wherein said aqueous alkaline solution (or said aqueous alkaline solution of an alumina source) is placed between a pair of said ring-shaped internal flanges.

25. The airtight vessel according to claim 23, wherein said support is a rod longitudinally extending in the center of said pipe beyond said porous substrate, wherein the projections of said cover members are tubular projections, and wherein with said cover members airtightly engaging the ends of said pipe, a portion of said support extending from an end surface of said porous substrate is inserted into said tubular projection.

26. The airtight vessel according to claim 25, wherein an elastic gasket is provided on the end surface of each tubular projection, thereby absorbing dimensional errors of said airtight vessel and said porous substrate in a state where said cover members airtightly engage the ends of said pipe.

27. The airtight vessel according to claim 25, wherein at least one of said tubular projections comprises a first tubular projection integrally protruding from an inner surface of said cover member, a second tubular projection disposed slidably around said first tubular projection, and an elastic member disposed between the inner surface of said cover member and said second tubular projection, the end of said second tubular projection having a flange abutting the end surface of said porous substrate, and said flange being provided with an elastic gasket.

28. The airtight vessel according to claim 23, wherein said projection comprises a stopper for said suspension container.

29. An apparatus for producing a silicon oxide-based ceramic membrane, comprising a plurality of airtight vessels recited in claim 17; a roller conveyor for transporting said airtight vessels while rotating; a heating furnace covering part of said roller conveyor; a supply station disposed on said roller conveyor upstream of said heating furnace for supplying said airtight vessels; and a cooling region and a takeout region of said airtight vessels disposed on said roller conveyor downstream of said heating furnace.

30. The apparatus for producing a silicon oxide-based ceramic membrane according to claim 29, comprising a region for loading a porous substrate into each airtight vessel; a region for supplying a silica source and an aqueous alkaline solution (or an aqueous alkaline solution of an alumina source) into each airtight vessel; a region for heating said airtight vessels; a region for cooling said airtight vessels; and a region for taking said porous substrate out of each airtight vessel, in this order along the path of said airtight vessels.

31. An apparatus for producing a silicon oxide-based ceramic membrane, comprising a plurality of airtight vessels recited in claim 17, a plurality of rollers for rotating said airtight vessels, a frame having shelves each supporting said rollers rotatably, an endless chain engaging said rollers, and a means for driving said endless chain.

32. An apparatus for producing a silicon oxide-based ceramic membrane, comprising a plurality of airtight vessels recited in claim 23; a roller conveyor for transporting said airtight vessels while rotating; a heating furnace covering part of said roller conveyor; a supply station disposed on said roller conveyor upstream of said heating furnace for supplying said airtight vessels; and a cooling region and a takeout region of said airtight vessels disposed on said roller conveyor downstream of said heating furnace.

33. The apparatus for producing a silicon oxide-based ceramic membrane according to claim 32, comprising a region for loading a porous substrate into each airtight vessel; a region for supplying a silica source and an aqueous alkaline solution (or an aqueous alkaline solution of an alumina source) into each airtight vessel; a region for heating said airtight vessels; a region for cooling said airtight vessels; and a region for taking said porous substrate out of each airtight vessel, in this order along the path of said airtight vessels.

34. An apparatus for producing a silicon oxide-based ceramic membrane, comprising a plurality of airtight vessels recited in claim 23, a plurality of rollers for rotating said airtight vessels, a frame having shelves each supporting said rollers rotatably, an endless chain engaging said rollers, and a means for driving said endless chain.
